(19) United States
(12) Patent Application Publication
(10) Pub. No.: US 2020/0226703 A1
(43) Pub. Date: Jul. 16, 2020

(54) SYSTEMS AND METHODS FOR PERSONALIZED REAL-TIME TERMS OF SERVICE ANALYSIS AND NEGOTIATION

(71) Applicant: Capital One Services, LLC, McLean, VA (US)

(72) Inventors: Fardin Abdi Taghi ABAD, Seattle, WA (US); Jeremy Edward GOODSITT, McLean, VA (US); Austin WALTERS, McLean, VA (US); Anh TRUONG, McLean, VA (US); Kenneth TAYLOR, Champaign, IL (US); Mark WATSON, Urbana, IL (US); Reza FARIVAR, McLean, VA (US); Vincent PHAM, McLean, VA (US)

(21) Appl. No.: 16/506,164

(22) Filed: Jul. 9, 2019

Related U.S. Application Data
(60) Provisional application No. 62/793,109, filed on Jan. 16, 2019.

(51) Int. Cl. G06Q 50/18; G06F 17/27; G06N 20/00; G06F 9/54; H04L 29/08

(52) U.S. Cl. CPC G06Q 50/188; G06F 17/27; H04L 67/26; G06F 9/54; G06N 20/00

(57) ABSTRACT

A system for performing one or more steps of a method is disclosed. The method includes receiving user preferences regarding terms of service that a user of the user device is willing to agree to and determining a set of user preference rules. The method also includes receiving a user request to access content provided by a content provider system, receiving a terms of service document, and determining a set of content provider preference rules. After determining the set of user preference rules and the set of content provider preference rules, the system compares the user preference rules with the content provider preferences rules to determine a match status and, based on the determination, generates and transmits either an approval message or a warning message.

### CROSS REFERENCE TO RELATED APPLICATIONS AND PRIORITY CLAIM

This Application is a non-provisional of, and claims priority under 35 U.S.C. § 119(e) to, U.S. Provisional Application No. 62/793,109, filed Jan. 16, 2019, of the same title, which is hereby incorporated by reference as if fully set forth below.

### FIELD OF INVENTION

The present disclosure relates to systems and methods for providing personalized real-time terms of service analysis and negotiation, and more particularly to systems and methods to convert legal clauses (e.g., terms of service documents, cookie agreements document, terms of use, terms and conditions, etc.) and user preferences to sets of logical rules, comparing the sets of logical rules, and determining whether the user preferences align with the terms of service based on the comparison.

### BACKGROUND

Legal documents tend to be difficult to read, understand, and compare, often due to the presence of archaic jargon or “legalese.” As a result, it can be hard for involved parties to understand and compare the implications of various terms or clauses included in their documents or agreements. The analysis is even further complicated by the fact that specific legal terms or clauses could have different implications depending on the location (e.g., jurisdiction) in which they are used. Even for those who can understand complex legal documents, analyzing and comparing the documents can take considerable time and, in turn, expense.

A nonlimiting example of this problem is exemplified through terms of service documents that are presented to a user in real-time. This typically occurs when a user is attempting to access content from a content provider either through a website or some other digital medium (e.g., mobile application, chatbot, etc.). In order to access the content, a user is typically presented with a terms of service document that the user is asked to sign before accessing the content. These terms of service documents can be hard to understand for the reasons previously discussed. As such, reading these agreements takes time that a user may not be willing or have time to expend. Further, due to the fact that a user is typically in a nonideal bargaining position and the user is attempting to access content in real time, there tends to be no chance for a user to negotiate terms of the agreement before signing.

Accordingly, there is a need for systems and methods for providing for real-time terms of service analysis and negotiation in an efficient way. Embodiments of the present disclosure are directed to this and other considerations.

### SUMMARY

Disclosed embodiments provide systems and methods for providing personalized real-time terms of service analysis and negotiation.

Consistent with the disclosed embodiments, various methods and systems are disclosed. In an embodiment, a system performing a method for providing personalized real-time terms of service analysis and negotiation. The method may include receiving user preferences regarding terms of service that a user of the user device is willing to agree to. In addition, the method may include determining, based at least in part on the user preferences, a set of user preference rules. Further, the method may include receiving a user request to access content provided by a content provider system. The method may also include receive a terms of service document from the content provider system. The method may include determining, based at least in part on applying natural language processing and machine learning to the terms of service document, a set of content provider preferences rules. Further, the method may include comparing the user preference rules with the content provider preference rules in order to determine a match status. If the match status indicates that the user preferences align with the terms of service, the method may include generating an approval message and transmitting the approval message comprising the match status and analysis data including a summary and explanation of relevant terms of service from the terms of service document to the user device. If the match status indicates that the user preferences do not align with the terms of service, the method may include generating a warning message comprising the match status, analysis data including a summary and explanation of non-aligning terms of service from the terms of service document, and a list of user options including an option to proceed to view the content or not, and transmitting the warning message to the user device.

The method may further include embodiments wherein the list of user options is presented on a display of the user device as a two-way push notification. Further, the method may include receiving, from the user device via the real-time API configured to provide terms of service analysis, a user selection comprising an indication of whether or not the user wishes to view the content. Based on a determination that the user selection indicates that the user wishes to view the content, the method may include providing the user with access to the content. Based on a determination that the user selection indicates that the user does not wish to view the content, the method may include denying the user access to the content.

In some example implementations, the method may include storing a user interaction file comprising data indicative of the terms of service document, the user preferences, the match status and the user selection. The method may also include tracking historical transaction data for a plurality of users who attempt to access the content provided by a content provider system, the historical transaction data comprising aggregated user interaction files. The method may include determining, using machine learning and based on the tracked historical transaction data, one or more content provider suggestion. Further, the method may include providing, to the content provider system, the one or more content provider suggestion. Further, the method may include embodiments wherein the one or more content provider suggestion comprises (i) an indication of a relevant term and (ii) a suggested change to the relevant term. Also, the method may include embodiments wherein the relevant term relates to a length of time in which a user's data is retained by the content provider system and the suggest change involves decreasing the length of time by a specified amount. Additionally, the method may include embodiments wherein the relevant term relates to a length of time in which a user's data is retained by the content provider system and the suggest change involves decreasing the length of time by a specified amount.

According to some example embodiments, the method may include tracking historical transaction data for a plurality of attempts by the user to access content provided by a plurality of content provider systems, the historical transaction data comprising aggregated user interaction files. The method may also include determining, using machine learning and based on the tracked historical transaction data, one or more user suggestion. Further, the method may include providing, to the user, the one or more user suggestion. In some example implementations, the one or more content user suggestions may comprise: (i) an indication of a relevant term and (ii) a suggested change to the relevant term.

In some example embodiments of the disclosed invention, the method may include receiving, from the user device, a user preference document comprising one or more user preferences. Additionally, the method may include determining, based at least in part on applying natural language processing and machine learning to the user preference document, a set of user preferences rules.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a diagram of an example system environment that may be used to implement one or more embodiments of the present disclosure;

FIG. 2 is a component diagram of a service provider system according to an example embodiment;

FIG. 3 is a component diagram of a computing device according to an example embodiment;

FIG. 4 is a flowchart of a method for providing personalized real-time terms of service analysis according to an example embodiment; and

FIG. 5 is a flowchart of a method for providing personalized real-time terms of service analysis and negotiation according to an example embodiment.

FIG. 6 is a flowchart of a method for providing personalized real-time terms of service analysis and negotiation according to an example embodiment.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

As used herein, the term “legalese” refers to the specialized language of the legal profession. The goal of this disclosure is to translate legalese to plain English.

This disclosure discusses the use of a neural network (NN) to translate from a normalized legal clause to a logical rule set. It is envisioned that the NN could be a recurrent neural network (RNN), a convolutional neural network (CNN), a recurrent convolutional neural network (RCNN), or any other suitable neural network.

Reference will now be made in detail to example embodiments of the disclosed technology, examples of which are illustrated in the accompanying drawings and disclosed herein. Wherever convenient, the same references numbers will be used throughout the drawings to refer to the same or like parts.

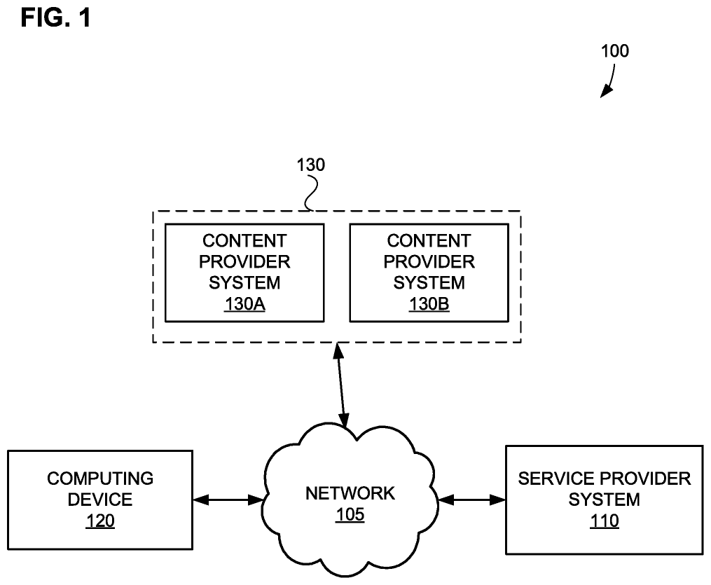

FIG. 1 is a diagram of an example system environment that may be used to implement one or more embodiments of the present disclosure. The components and arrangements shown in FIG. 1 are not intended to limit the disclosed embodiments as the components used to implement the disclosed processes and features may vary. In one aspect, as shown, a system 100 may include a service provider system 110, a computing device 120, and one or more content provider systems 130A and 130B (collectively, content provider system 130) configured to communicate with one another via a network 105. In some embodiments, the service provider system 110 may also be in communication with various databases (not shown). The computing device 120 may be a mobile computing device (e.g., a smart phone, tablet computer, smart wearable device, portable laptop computer, voice command device, wearable augmented reality device, or other mobile computing device) or a stationary device (e.g., desktop computer).

In some embodiments, the service provider system 110 may receive, from computing device 120 via a real-time API configured to provide terms of service analysis, user preferences regarding terms of service that a user of the user device is willing to agree to. For example, in some embodiments a user may be presented with common terms of service and asked to provide an indication of whether or not they agree to disagree with such terms. According to some embodiments, a user may be able to provide custom terms of service that they will or will not agree to. In some embodiments, for example, a user may prefer that their generated data never be stored. As another example, a user may specify certain parties (e.g., companies, service providers, etc.) that they are willing to share their data while, while specifying other parties that they will not share their data with. In some implementations, the user preferences may be gleaned from previous terms of service documents that the user has agreed to be bound by. For example, if they user has always accepted terms of service specifying that the user data may be stored for 30 days, then a user preference associated with the user may indicate the user is willing to have their data stored for 30 days.

Additionally, the service provider system 110 may determine, based at least in part on the user preferences, a set of user preference rules. Further, the service provider system 110 may receive, from the computing device 120 via a real-time API configured to provide terms of service analysis, a user request to access content provided by a content provider system. The service provider system 110 may also receive, from the content provider system 130 via a real-time API configured to provide terms of service analysis, a terms of service document. The service provider system 110 may determine, based at least in part on applying natural language processing and machine learning to the terms of service document, a set of content provider preferences rules. Based on a comparison of the user preference rules with the content provider preference rules, the service provider system 110 may determine a match status. Based on a determination that the match status indicates that the user preferences align with the terms of service, the service provider system 110 may generate an approval message and transmit, to the user device, the approval message comprising the match status and analysis data including a summary and explanation of relevant terms of service from the terms of service document.

Additionally, in some example embodiments, sentence embedding, fuzzy logic, or any other suitable technique may be used to match the intent of the user preferences with the intent of the terms of service. Based on a determination that the match status indicates that the user preferences do not align with the terms of service, the service provider system 110 may generate a warning message, the warning message comprising the match status, analysis data including a summary and explanation of non-aligning terms of service from the terms of service document, and a list of user options including an option to proceed to view the content or not, and the service provider system 110 may transmit, to the user device via a real-time API configured to provide terms of service analysis, the warning message.

Network 105 may be of any suitable type, including individual connections via the internet such as cellular or WiFi networks. In some embodiments, network 105 may connect terminals using direct connections such as radio-frequency identification (RFID), near-field communication (NFC), Bluetooth™, low-energy Bluetooth™ (BLE), WiFi™, ZigBee™ ambient backscatter communications (ABC) protocols, USB, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

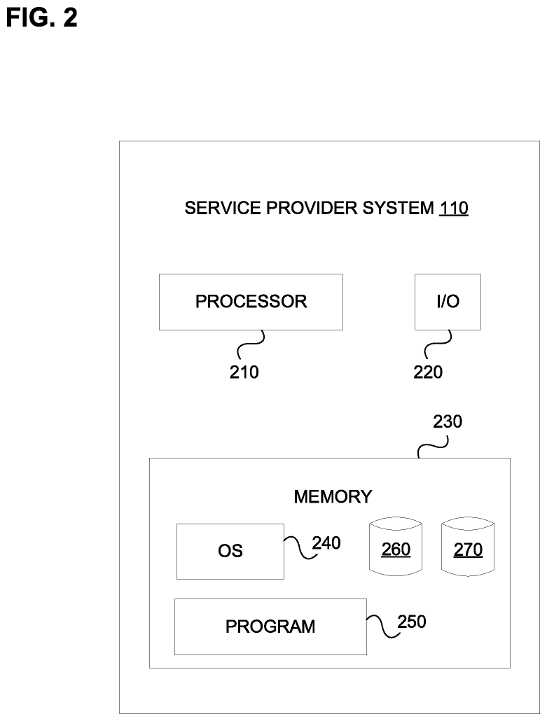

An example embodiment of the service provider system 110 is shown in more detail in FIG. 2. The computing device 120 may have a similar structure and one or more components that are similar to those described with respect to the service provider system 110. As shown, the service provider system 110 may include a processor 210, an input/output (“I/O”) device 220, a memory 230 containing an operating system (“OS”) 240 and a program 250. For example, the service provider system 110 may be a single server or may be configured as a distributed computer system including multiple servers or computers that interoperate to perform one or more of the processes and functionalities associated with the disclosed embodiments. In some embodiments, the service provider system 110 may further include a peripheral interface, a transceiver, a mobile network interface in communication with the processor 210, a bus configured to facilitate communication between the various components of the service provider system 110, and a power source configured to power one or more components of service provider system 110.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general-purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™ ambient backscatter communications (ABC) protocols or similar technologies.

A mobile network interface may provide access to a cellular network, the Internet, or another wide-area network. In some embodiments, a mobile network interface may include hardware, firmware, and/or software that allows the processor 210 to communicate with other devices via wired or wireless networks, whether local or wide area, private or public, as known in the art. A power source may be configured to provide an appropriate alternating current (AC) or direct current (DC) to power components.

As described above, the service provider system 110 may configured to remotely communicate with one or more other devices, such as the computer device 120 and the content provider system 130. According to some embodiments, the service provider system 110 may utilize a NN, word embeddings, a Markov chain, or a probabilistic parser to translate legal clauses (e.g., terms of service documents) and user preferences to sets logical rules, comparing the sets of logical rules, and determining whether the user preferences align with the terms of service based on the comparison.

Processor 210 may include one or more of a microprocessor, microcontroller, digital signal processor, co-processor or the like or combinations thereof capable of executing stored instructions and operating upon stored data. Memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 230.

Processor 210 may be one or more known processing devices, such as a microprocessor from the Pentium™ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Service provider system 110 may include one or more storage devices configured to store information used by processor 210 (or other components) to perform certain functions related to the disclosed embodiments. In one example, service provider system 110 may include memory 230 that includes instructions to enable processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, service provider system 110 may include memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, service provider system 110 may include memory 230 that may include one or more programs 250 to perform one or more functions of the disclosed embodiments. Moreover, processor 210 may execute one or more programs 250 located remotely from service provider system 110. For example, service provider system 110 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational databases. Memory 230 may include software components that, when executed by processor 210, perform one or more processes consistent with the disclosed embodiments. In some embodiments, memory 230 may include an image processing database 260 and a neural-network pipeline database 270 for storing related data to enable service provider system 110 to perform one or more of the processes and functionalities associated with the disclosed embodiments.

Service provider system 110 may also be communicatively connected to one or more memory devices (e.g., databases (not shown)) locally or through a network. The remote memory devices may be configured to store information and may be accessed and/or managed by service provider system 110. By way of example, the remote memory devices may be document management systems, Microsoft™ SQL database, SharePoint™ databases, Oracle™ databases, Sybase™ databases, or other relational databases. Systems and methods consistent with disclosed embodiments, however, are not limited to separate databases or even to the use of a database.

Service provider system 110 may also include one or more I/O devices 220 that may include one or more interfaces for receiving signals or input from devices and providing signals or output to one or more devices that allow data to be received and/or transmitted by service provider system 110. For example, service provider system 110 may include interface components, which may provide interfaces to one or more input devices, such as one or more keyboards, mouse devices, touch screens, track pads, trackballs, scroll wheels, digital cameras, microphones, sensors, and the like, that enable service provider system 110 to receive data from one or more users (such as via computing device 120).

In example embodiments of the disclosed technology, service provider system 110 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While service provider system 110 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the service provider system 110 may include a greater or lesser number of components than those illustrated.

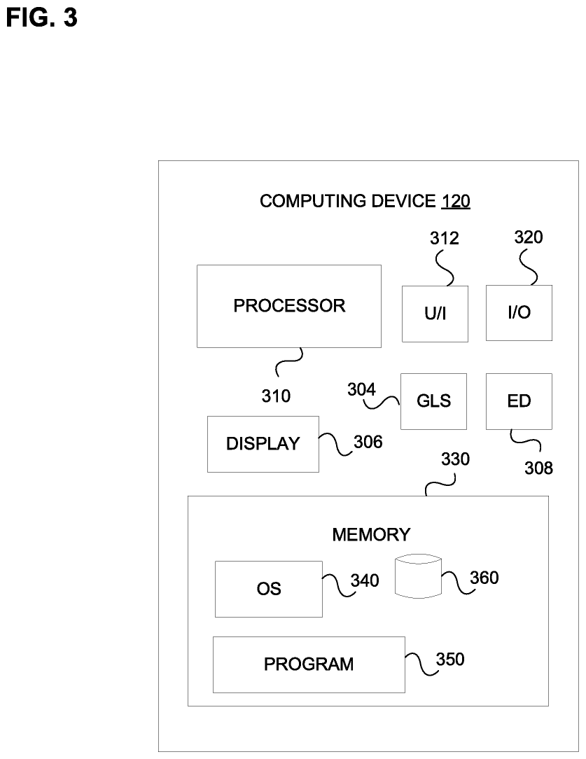

FIG. 3 shows an example embodiment of computing device 120 (e.g., a user device 120). As shown, computing device 120 may include input/output (“I/O”) device 320 for receiving data from another device (e.g., service provider system 110), memory 330 containing operating system (“OS”) 340, program 350, and any other associated component as described above with respect to service provider system 110. Computing device 120 may also have one or more processors 310, a geographic location sensor (“GLS”) 304 for determining the geographic location of computing device 120, a display 306 for displaying content such as text (e.g., patent claims or legal clauses), text messages, images, and selectable buttons/icons/links, an environmental data (“ED”) sensor 308 for obtaining environmental data including audio and/or visual information, and a user interface (“U/I”) device 312 for receiving user input data, such as data representative of a click, a scroll, a tap, a press, or typing on an input device that can detect tactile inputs. User input data may also be non-tactile inputs that may be otherwise detected by ED sensor 308. For example, user input data may include auditory commands. According to some embodiments, U/I device 312 may include some or all of the components described with respect to input/output device 320 above. In some embodiments, environmental data sensor 308 may include a microphone and/or an image capture device, such as a digital camera.

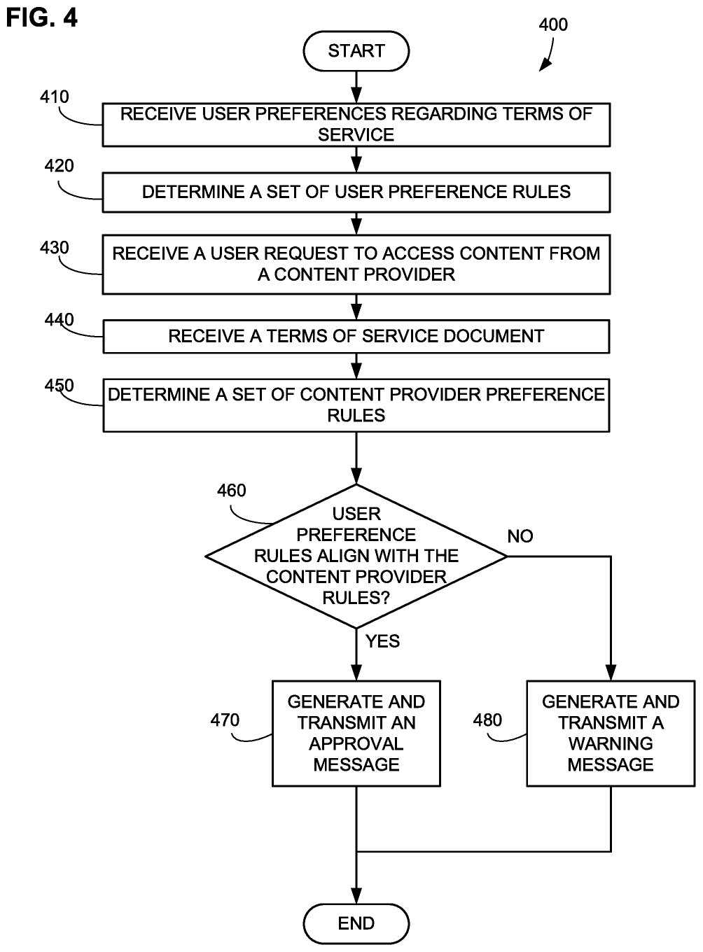

FIG. 4 shows a flowchart of a method 400 for providing personalized real-time terms of service analysis. Method 400 may be performed by one or more of the service provider system 110, the computing device 120, and the content provider system 130 of the system 100.

In block 410 of method 400 in FIG. 4, the system may receive, from a user device via a real-time API configured to provide terms of service analysis, user preferences regarding terms of service that a user of the user device is willing to agree to. In some embodiments, a user may provide user preferences by entering them into a mobile application running on the user device (e.g., computing device 120). The user device may then provide the preferences to the real-time API when a user initiates a content request on the user device. In some cases, the user the real-time API may provide a user with a list of questions with selectable options.

In block 420, the system may determine, based at least in part on the user preferences, a set of user preference rules. In some embodiments, the user preference rules may include generalized preferences based on the user preferences and other user information. For example, in some embodiments, the user preferences rules may be based on the user preferences and any local laws or regulations associated with the location of the user device.

In block 430, the system may receive, from a user device (e.g., computing device 120) via a real-time API configured to provide terms of service analysis, a user request to access content provided by a content provider system (e.g., content provider system 130). For example, a user may attempt to access a webpage through a web browser. In some embodiments, the web browser may have installed an API, which reroutes the attempt to the system.

In block 440, the system may receive, from the content provider system (e.g., content provider system 130) via a real-time API configured to provide terms of service analysis, a terms of service document.

In block 450, the system may determine, based at least in part on applying natural language processing and machine learning to the terms of service document, a set of content provider preferences rules.

In block 460, based on a comparison of the user preference rules with the content provider preference rules, the system may determine a match status.

In block 470, based on a determination that the match status indicates that the user preferences align with the terms of service, the system may generate an approval message and may transmit, to the user device, the approval message comprising the match status and analysis data including a summary and explanation of relevant terms of service from the terms of service document.

In block 480, based on a determination that the match status indicates that the user preferences do not align with the terms of service, the system may generate a warning message, the warning message comprising the match status, analysis data including a summary and explanation of non-aligning terms of service from the terms of service document, and a list of user options including an option to proceed to view the content or not. The system may then transmit, to the user device via a real-time API configured to provide terms of service analysis, the warning message.

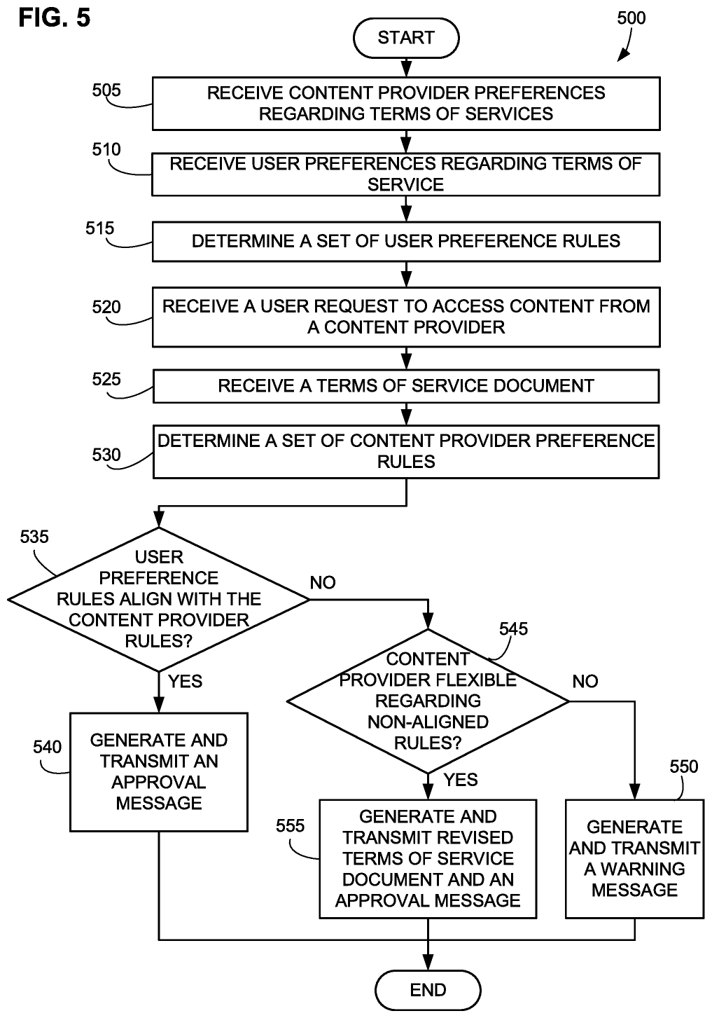

FIG. 5 shows a flowchart of a method 500 for providing personalized real-time terms of service analysis and negotiation. Method 500 may be performed by one or more of the service provider system 110, the computing device 120, and the content provider system 130 of the system 100.

In block 505 of method 500 in FIG. 5, the system may receive, from a content provider system, content provider preferences indicating areas in which the content provider system (e.g., content provider system 130) is flexible with regards to terms of service.

In block 510, the system may receive, from a user device (e.g., computing device 120) via a real-time API configured to provide terms of service analysis, user preferences regarding terms of service that a user of the user device is willing to agree to. In some embodiments, a user may provide user preferences by entering them into a mobile application running on the user device. The user device may then provide the preferences to the real-time API when a user initiates a content request on the user device. In some cases, the user the real-time API may provide a user with a list of questions with selectable options.

In block 515, the system may determine, based at least in part on the user preferences, a set of user preference rules. In some embodiments, the user preference rules may include generalized preferences based on the user preferences and other user information. For example, in some embodiments, the user preferences rules may be based on the user preferences and any local laws or regulations associated with the location of the user device (e.g., computing device 120).

In block 520, the system may receive, from a user device (e.g., computing device 120) via a real-time API configured to provide terms of service analysis, a user request to access content provided by the content provider system (e.g., content provider system 130). In block 525, the system may receive, from the content provider system (e.g., content provider system 130) via a real-time API configured to provide terms of service analysis, a terms of service document.

In block 530, the system may determine, based at least in part on applying natural language processing and machine learning to the terms of service document, a set of content provider preferences rules.

In block 535, based on a comparison of the user preference rules with the content provider preference rules, the system may determine a match status.

In block 540, based on a determination that the match status indicates that the user preferences align with the terms of service, the system may generate an approval message and may transmit, to the user device, the approval message comprising the match status and analysis data including a summary and explanation of relevant terms of service from the terms of service document.

In block 545, based on a determination that the match status indicates that the user preferences do not align with the terms of service, to the system may determine, based on the content provider preferences, whether the content provider system is flexible with regards to non-aligning terms of service from the terms of service document.

In block 550, responsive to determining, based on the content provider preferences, that the content provider system is not flexible with regards to non-aligning terms of service from the terms of service document, the system may generate a warning message comprising (1) the match status (2) analysis data including a summary and an explanation of non-aligning terms of service from the terms of service document and (3) a list of user options including an option to proceed to view the content or not, and the system may transmit, to the user device via a real-time API configured to provide terms of service analysis, the warning message.

In block 555, responsive to determining, based on the content provider preferences, that the content provider system is flexible with regards to non-aligning terms of service from the terms of service document, the system may generate a revised terms of service document and transmit the revised terms of service document to the content provider system and the user device.

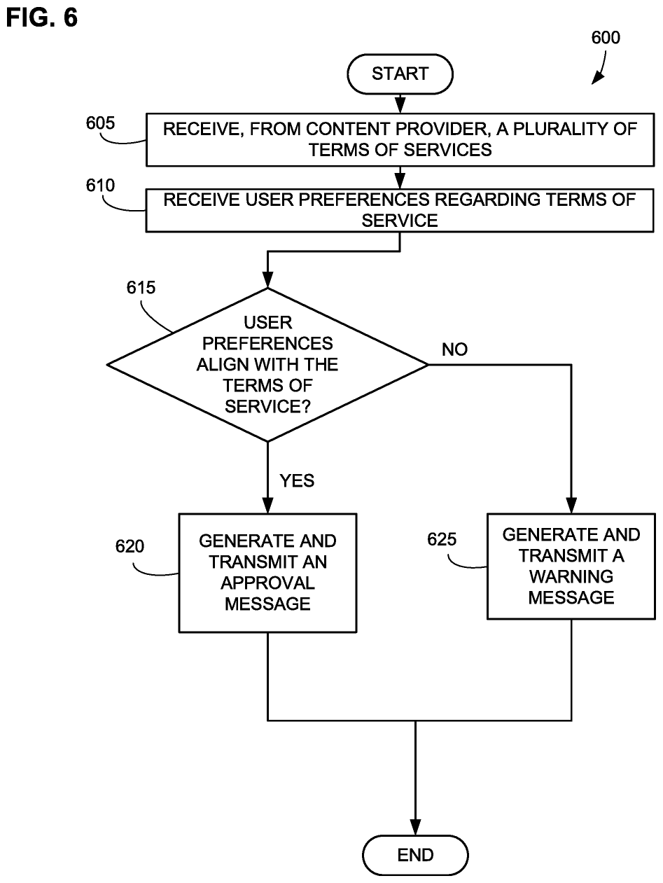

FIG. 6 shows a flowchart of a method 600 for providing personalized real-time terms of service analysis and negotiation. Method 600 may be performed by one or more of the service provider system 110, the computing device 120, and the content provider system 130 of the system 100.

In block 605, the system may receive, from the content provider system via the real-time API configured to provide terms of service analysis, a plurality of terms of service. For example, in some embodiments, the system may provide, to the content provider system via the real-time API configured to provide terms of service analysis, a plurality of terms of service options. The system may then receive, from the content provider system via the real-time API configured to provide terms of service analysis, a plurality of terms of service preferences, each of the plurality of terms of service preferences corresponding to a respective terms of service option. In some example implementations, the system may communication with the content provider system through a mobile or desktop application. In some embodiments, the terms of service may be expressed in a logical language. For example, the terms of service may be coded or written in a way that allows for Boolean comparison to similarly coded data (e.g., user preferences).

In block 610, the system may receive, from a user device via a real-time API configured to provide terms of service analysis, user preferences regarding terms of service that a user of the user device is willing to agree to;

In block 615, the system may receive, from the user device via the real-time API configured to provide terms of service analysis, a user request to access content provided by a content provider system.

In block 620, based on a comparison of the user preference with the plurality of terms of service, the system may determine a match status.

In block 625, based on a determination that the match status indicates that the user preferences align with the terms of service, the system may generate an approval message and transmit, to the user device, the approval message comprising (1) the match status and (2) analysis data comprising a summary and explanation of one or more relevant terms of service from the plurality of terms of service document.

In block 630, based on a determination that the match status indicates that the user preferences do not align with the terms of service, the system may generate a warning message, the warning message comprising (1) the match status, (2) analysis data including a summary and explanation of non-aligning terms of service from the terms of service document, and (2) a list of user options including an option to proceed to view the content or not.

In block 635, the system may transmit, to the user device via the real-time API configured to provide terms of service analysis, the warning message.

Certain implementations provide the advantage of easily comparing user preferences with legal terms of services documents and for providing negotiation of terms.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### EXAMPLE USE CASE

The following example use case describes an example of a typical use of comparing user terms of service preferences with a terms of service document. It is intended solely for explanatory purposes and not in limitation. In one example, a user inputs user preferences regarding terms of service that a user of the user device is willing to agree to a mobile application running on their cell phone or portable laptop computer (e.g., computing device 120). Regardless, a user may, via a website on their cell phone or portable laptop computer (e.g., computing device 120), answer questions regarding potential terms of services from the service provider system 110 for processing. In other words, the service provider system 110 prompts the user with a list of questions and received the users answers or preferences. The service providers system 110 then generates a user preference rule set corresponding to the received user answers. Once the user has entered their responses, the user may attempt to access content from a service provider. For example, a user may visit a webpage through a web browser on their cell phone or portable laptop computer (e.g., computing device 120). Upon loading a website into a web browser, the service provider system 110 may locate and acquire the web site's terms of service document(s). The service provider system 110 may then translate the legalese provisions from the terms of service document and compare the translated document to the user's preferences in order to determine whether or not the terms of the terms of service document comport with the user's preferences. If the service provider system 110 determines that the terms of the terms of service document align with the user's preferences, then the service provider system 110 will generate an authorization message and send it to the user (e.g., via user device). If the service provider system 110 determines that the terms of the terms of service document do not align with the user's preferences, then the service provider system 110 will generate a warning message and send it to the user (e.g., via user device).

1. A system for providing real-time personalized terms of service analysis for incorporation into a web browser via an API, the system comprising:
one or more processors and a memory in communication with the one or more processors and storing instructions that, when executed by the one or more processors, cause the system to:
receive, from a user device via a real-time API configured to provide terms of service analysis, user preferences regarding terms of service that a user of the user device is willing to agree to;
determine, based at least in part on the user preferences, a set of user preference rules;
receive, from the user device via the real-time API configured to provide terms of service analysis, a user request to access content provided by a content provider system;
receive, from the content provider system via the real-time API configured to provide terms of service analysis, a terms of service document;
determine, based at least in part on applying natural language processing and machine learning to the terms of service document, a set of content provider preferences rules;
based on a comparison of the set of user preference rules with the set of content provider preference rules, determine a match status;
based on a determination that the match status indicates that the user preferences align with the terms of service, generate an approval message and transmit, to the user device, the approval message comprising the match status and analysis data comprising a summary and explanation of relevant terms of service from the terms of service document; and
based on a determination that the match status indicates that the user preferences do not align with the terms of service:
generate a warning message, the warning message comprising the match status, analysis data including a summary and explanation of non-aligning terms of service from the terms of service document, and a list of user options including an option to proceed to view the content or not, and
transmit, to the user device via the real-time API configured to provide terms of service analysis, the warning message.

2. The system of claim 1, wherein the list of user options is presented on a display of the user device as a two-way push notification.

3. The system of claim 1 further comprising instruction that, when executed by the one or more processors, cause the system to:
receive, from the user device via the real-time API configured to provide terms of service analysis, a user selection comprising an indication of whether or not the user wishes to view the content;
based on a determination that the user selection indicates that the user wishes to view the content, provide the user with access to the content; and
based on a determination that the user selection indicates that the user does not wish to view the content, deny the user access to the content.

4. The system of claim 3 further comprising instruction that, when executed by the one or more processors, cause the system to:
store a user interaction file comprising data indicative of the terms of service document, the user preferences, the match status and the user selection.

5. The system of claim 4 further comprising instruction that, when executed by the one or more processors, cause the system to:
track historical transaction data for a plurality of users who attempt to access the content provided by a content provider system, the historical transaction data comprising aggregated user interaction files; and
determine, using machine learning and based on the tracked historical transaction data, one or more content provider suggestions; and
provide, to the content provider system, the one or more content provider suggestions.

6. The system of claim 5, wherein the one or more content provider suggestions comprise (i) an indication of a relevant term and (ii) a suggested change to the relevant term.

7. The system of claim 6, wherein the relevant term relates to a length of time in which a user's data is retained by the content provider system and the suggested change involves decreasing the length of time by a specified amount.

8. The system of claim 6, wherein the relevant term relates to a length of time in which a user's data is retained by the content provider system and the suggested change involves decreasing the length of time by a specified amount.

9. The system of claim 4 further comprising instruction that, when executed by the one or more processors, cause the system to:
track historical transaction data for a plurality of attempts by the user to access content provided by a plurality of content provider systems, the historical transaction data comprising aggregated user interaction files; and
determine, using machine learning and based on the tracked historical transaction data, one or more user suggestions; and
provide, to the user, the one or more user suggestions.

10. The system of claim 9, wherein the one or more user suggestions comprise: (i) an indication of a relevant term and (ii) a suggested change to the relevant term.

11. The system of claim 1, wherein receiving user preferences comprises:
receiving, from the user device, a user preference document comprising one or more user preferences.

12. The system of claim 11, wherein determining a set of user preference rules comprises:
determine, based at least in part on applying natural language processing and machine learning to the user preference document, a set of user preferences rules.

13. A system for providing real-time personalized terms of service analysis and negotiation for incorporation into a web browser via an API, the system comprising:
one or more processors; and
a memory in communication with the one or more processors and storing instructions that, when executed by the one or more processors, cause the system to:
receive, from a content provider system, content provider preferences indicating areas in which the content provider system is flexible with regards to terms of service;
receive, from a user device via a real-time API configured to provide terms of service analysis and negotiation, user preferences regarding terms of service that a user of the user device is willing to agree to;
determine, based at least in part on the user preferences, a set of user preference rules;
receive, from a user device via a real-time API configured to provide terms of service analysis, a user request to access content provided by the content provider system;
receive, from the content provider system via a real-time API configured to provide terms of service analysis, a terms of service document;
determine, based at least in part on applying natural language processing and machine learning to the terms of service document, a set of content provider preferences rules;
based on a comparison of the set of user preference rules with the set of content provider preference rules, determine a match status;
based on a determination that the match status indicates that the user preferences align with the terms of service, generate an approval message and transmit, to the user device, the approval message comprising the match status and analysis data including a summary and explanation of relevant terms of service from the terms of service document; and
based on a determination that the match status indicates that the user preferences do not align with the terms of service:
responsive to determining, based on the content provider preferences, that the content provider system is flexible with regards to non-aligning terms of service from the terms of service document, generate a revised terms of service document and transmit the revised terms of service document to the content provider system and the user device;
responsive to determining, based on the content provider preferences, that the content provider system is not flexible with regards to non-aligning terms of service from the terms of service document, generate a warning message comprising (1) the match status (2) analysis data including a summary and an explanation of non-aligning terms of service from the terms of service document and (3) a list of user options including an option to proceed to view the content or not, and
transmit, to the user device via a real-time API configured to provide terms of service analysis, the warning message.

14. The system of claim 13, wherein receiving user preferences comprises:
providing, to a mobile application running on the user device, a plurality of preference questions; and
receiving, from the mobile application running on the user device, a plurality of user preferences, each preference corresponding to a respective preference question.

15. The system of claim 13 further comprising instruction that, when executed by the one or more processors, cause the system to:
provide, to the content provider system, a plurality of terms of service options;
receiving, from the content provider system, a plurality of terms of service preferences, each preference corresponding to a respective option; and
aggregating the plurality of terms of service preferences in order to generate a terms of service document.

16. A system for providing real-time personalized terms of service analysis for incorporation into a web browser via a real-time API, the system comprising:
one or more processors; and
a memory in communication with the one or more processors and storing instructions that, when executed by the one or more processors, cause the system to:
receive, from a content provider system via the real-time API configured to provide terms of service analysis, a plurality of terms of service;
receive, from a user device via a real-time API configured to provide terms of service analysis, user preferences regarding terms of service that a user of the user device is willing to agree to;
receive, from the user device via the real-time API configured to provide terms of service analysis, a user request to access content provided by a content provider system;
based on a comparison of the user preference with the plurality of terms of service, determine a match status;
based on a determination that the match status indicates that the user preferences align with the terms of service, generate an approval message and transmit, to the user device, the approval message comprising (1) the match status and (2) analysis data comprising a summary and explanation of one or more relevant terms of service from the plurality of terms of service; and
based on a determination that the match status indicates that the user preferences do not align with the terms of service:
generate a warning message, the warning message comprising (1) the match status, (2) analysis data including a summary and explanation of non-aligning terms of service from the plurality of terms of service, and (2) a list of user options including an option to proceed to view the content or not, and
transmit, to the user device via the real-time API configured to provide terms of service analysis, the warning message.

17. The system of claim 16, wherein receiving user preferences comprises:
providing, to the user device via the real-time API configured to provide terms of service analysis, a plurality of preference questions; and
receiving, from the user device via the real-time API configured to provide terms of service analysis, a plurality of user preferences, each preference corresponding to a respective preference question.

18. The system of claim 17, wherein receiving the plurality of terms of service comprises:
providing, to the content provider system via the real-time API configured to provide terms of service analysis, a plurality of terms of service options; and
receiving, from the content provider system via the real-time API configured to provide terms of service analysis, a plurality of terms of service preferences, each of the plurality of terms of service preferences corresponding to a respective terms of service option.

19. The system of claim 18, wherein the plurality of terms of service and the user preferences are expressed using a logical language.

20. The system of claim 16, wherein the list of user options further comprises an option to negotiate the terms of service with the content provider system.
